(19) United States
(12) Patent Application Publication
(10) Pub. No.: US 2019/0224947 A1
(43) Pub. Date: Jul. 25, 2019

(54) SYSTEM OF A REINFORCED ELEMENT OF A MOTOR VEHICLE

(71) Applicant: SIKA TECHNOLOGY AG, Baar (CH)

(72) Inventors: Noah MUNZINGER, Zurich (CH); Urs RHEINEGGER, Regensdorf (CH); Urs JÄGER, Jona (CH)

(73) Assignee: SIKA TECHNOLOGY AG, Baar (CH)

(21) Appl. No.: 16/257,873

(22) Filed: Jan. 25, 2019

(30) Foreign Application Priority Data
Jan. 25, 2018 (EP) 18153513.9

(51) Int. Cl. B32B 7/12; B62D 29/00; B32B 27/12; B32B 27/08

(52) U.S. Cl. CPC B32B 7/12; B62D 29/002; B32B 27/12; B32B 2260/021; B32B 2262/101; B32B 2260/046; B32B 2262/106; B32B 27/08

(57) ABSTRACT

A system of a reinforced element of a motor vehicle includes: an element of a motor vehicle; an adhesive, which is disposed on the element; and a sheetlike textile, which is disposed on the element; where the one adhesive likewise forms a matrix resin for fibres of the sheetlike textile and bonds the sheetlike textile to the element.

The present invention relates to a system of a reinforced element of a motor vehicle and also to a method for reinforcing an element of a motor vehicle.

Bodywork of motor vehicles is widely designed with lightweight constructions. In that case it is often desirable for these lightweight constructions to undergo targeted reinforcement at particular places. For example, regions of the bodywork in which cavities are formed may be reinforced by inserted reinforcing elements. Alternatively, reinforcing elements may also be bonded adhesively to extensive regions of the bodywork in order to reinforce them.

One established approach to reinforcing lightweight constructions in motor vehicles is to use an adhesive to bond prefabricated fibre-plastic composites to sections of the construction. In this case the fibre-plastic composites are preshaped and fully cured and then adhered to the construction of the motor vehicle. This is done typically using one-component thermosetting epoxy resin adhesives, which are fully cured typically in a paint oven.

A disadvantage of this known approach is that it requires previous production of the fibre-plastic composite parts, which is inconvenient, expensive, and time-consuming. Moreover, in the event of later design adaptations, it is necessary in each case to produce new tooling and/or moulds.

It is an object of the present invention, therefore, to provide an improved system of a reinforced element of a motor vehicle and an improved method for reinforcing an element of a motor vehicle, each of which is more cost-effective and at the same time amenable to more flexible application.

This object is achieved first by a system of a reinforced element of a motor vehicle, the system comprising: an element of a motor vehicle; an adhesive, which is disposed on the element; and a single sheetlike textile, which is disposed on the element; where the one adhesive likewise forms a matrix resin for fibres of the sheetlike textile and bonds the sheetlike textile to the element.

An advantage of this solution is that it does not require the production of prefabricated and preformed elements. Hence it is possible to do without both pre-production and construction of tooling, especially the manufacture of moulds. A further advantage is that the system proposed here can be adapted flexibly to a wide variety of different surface forms.

A core concept of the present invention is that the fibre-plastic composite reinforcing the element of the motor vehicle is not prefabricated but is instead formed directly on the element that is to be reinforced. In this case the individual components, in particular the sheetlike textile and the adhesive, are disposed individually or together onto the element that is to be reinforced, with the adhesive in this phase as yet not being fully cured. As a result, the sheetlike textile is flexible and can be adapted to a surface structure of the element that is to be reinforced.

The sheetlike textile and the adhesive are then formed in one step into a fibre-plastic composite, which is bonded onto the element: the full curing of the adhesive produces, on the one hand, the fibre-plastic composite, and on the other hand this composite is bonded simultaneously onto the element that is to be reinforced. Hence there is no longer a need for two different adhesives (one to produce the fibre-plastic composite, and a second to bond the fibre-plastic composite to the element that is to be reinforced); instead, these two adhesives are replaced by just a single adhesive, which fulfils both functions at the same time and so entails a great saving in terms of operations.

It is especially advantageous here that the finishing oven through which the bodywork is conveyed as a standard procedure can be utilized in order to cure the adhesive fully and at the same time to form the fibre-plastic composite and to bond this composite to the element that is to be reinforced.

In the solution proposed here, the system of a reinforced element of a motor vehicle is formed exclusively by a single sheetlike textile together with the adhesive and the element.

In one exemplary embodiment the adhesive is a curable adhesive.

In one exemplary development the adhesive is a heat-curable adhesive.

This has the advantage that the finishing oven which is utilized in standard procedure in the production of bodywork can be employed in order to cure the adhesive fully.

In one exemplary development the adhesive cures fully at a temperature of at least 120° C., preferably at a temperature of at least 140° C., more preferably at a temperature of at least 160° C.

In one exemplary embodiment the adhesive is an epoxy resin adhesive or a polyurethane adhesive.

In a further exemplary embodiment the adhesive is a one-component adhesive or a two-component adhesive.

A specific working example of a possible adhesive for implementing the present invention is a one-component thermosetting adhesive based on epoxy resin, this adhesive being obtainable under the tradename SikaPower®-497.

In one exemplary embodiment the adhesive after curing has a modulus of elasticity of at least 50 MPa, preferably of at least 100 MPa, preferably of at least 150 MPa, preferably of at least 200 MPa, more preferably of at least 300 MPa.

The advantage of an adhesive having an above-described modulus of elasticity after curing is that it allows particularly effective reinforcement of the element to be achieved.

In one exemplary embodiment the adhesive is disposed as a film of adhesive on the element.

In one exemplary embodiment the adhesive has an average thickness of 0.1 mm to 5.0 mm, preferably of 0.2 mm to 4 mm, more preferably of 0.5 mm to 3.0 mm.

In one exemplary development the adhesive has such an average thickness before full curing of the adhesive.

The provision of an adhesive or film of adhesive with the aforesaid average thickness offers the advantage that it provides sufficient adhesive to form a matrix for the fibres of the sheetlike textile and at the same time to bond the sheetlike textile to the element.

In one exemplary embodiment the sheetlike textile has a thickness of 0.5 mm to 1.5 mm, preferably of 0.6 mm to 1.4 mm, more preferably of 0.7 mm to 1.3 mm.

Sheetlike textiles with the above-stated thickness have the advantage that such textiles are particularly advantageous in terms of mechanical properties and weight for the reinforcement of elements of a motor vehicle.

In one exemplary embodiment the sheetlike textile comprises glass fibres or carbon fibres.

In this case it is possible to use only glass fibres, only carbon fibres, or else a mixture of different fibres.

In one exemplary embodiment the fibres of the sheetlike textile are impregnated.

Impregnating the fibres of the sheetlike textile offers the advantage that as a result it is possible to produce a better connection between the fibres and the matrix surrounding the fibres.

In one exemplary development the fibres of the sheetlike textile are impregnated with the same adhesive which is disposed on the element.

Using the same adhesive to impregnate the fibres and to form the matrix, and also to bond the sheetlike textile to the element, has the advantage on the one hand that operations can be simplified and on the other hand provides the assurance of an optimum attachment of the fibres to the matrix and to the element.

In one exemplary embodiment the element is a section of the bodywork, in particular a panel or a profile or a cast part, or a reinforcing element for reinforcing hollow structural elements of the bodywork.

The system proposed here, accordingly, can be used in diverse ways for reinforcing elements in motor vehicles.

In one exemplary embodiment the sheetlike textile is a loop-drawn knit, a woven fabric, a nonwoven scrim, a braided fabric or a loop-formed knit.

The sheetlike textile may be configured accordingly depending on requirements.

The object stated at the outset is further solved by a method for reinforcing an element of a motor vehicle, the method comprising the steps of: dispensing an adhesive on the element; dispensing a single sheetlike textile on the element; and curing the adhesive; where the adhesive likewise forms a matrix resin for fibres of the sheetlike textile and bonds the sheetlike textile to the element.

In one exemplary embodiment the adhesive and the sheetlike textile are disposed on the element in one step.

The advantage this offers is that it allows application to be simplified, by the adhesive and the sheetlike textile being disposed together onto the element.

In one exemplary embodiment the method comprises the further step of: impregnating the sheetlike textile in adhesive, before the sheetlike textile and the adhesive are disposed on the element.

In one exemplary alternative embodiment the method comprises the further step of: applying the adhesive on the sheetlike textile, in particular by spraying, scattering, painting, brushing, extruding or pouring, before the sheetlike textile and the adhesive are disposed on the element.

This has the advantage that it allows wetting of the fibres of the sheetlike textile with the adhesive to be improved, and that it allows the sheetlike textile and the adhesive to be applied together in one operation to the element.

In an alternative working example, the adhesive is disposed on the element before the sheetlike textile is disposed on the element.

This has the advantage that the sheetlike textile can be handled dry—in particular, mounted, trimmed and moved as dry textile.

In one exemplary embodiment the adhesive, on being disposed on the element, is sprayed, scattered, painted, brushed, extruded or poured onto the element.

A suitable mode of disposition may be selected in accordance with the overall operation in which the method proposed here is employed.

In one exemplary embodiment the adhesive is disposed on the element manually or with automation.

In one exemplary embodiment the sheetlike textile is disposed on the element manually or with automation.

In one exemplary embodiment, on disposition of the sheetlike textile on the element, the sheetlike textile is unwound as a strip on the element.

In one exemplary embodiment the sheetlike textile is trimmed before or after being disposed on the element.

In one exemplary embodiment the adhesive is cured in a finishing oven.

This has the advantage that it allows the adhesive to be fully cured utilizing an operation which typically takes place in any case. Hence there is no additional cost and effort needed in order to carry out full curing of the adhesive.

In one exemplary embodiment the method comprises the additional step of: impregnating the fibres of the sheetlike textile before the adhesive comes into contact with the sheetlike textile.

This has the advantage that the fibres of the sheetlike textile are wetted more effectively as a result.

In one exemplary development the fibres are impregnated with the same adhesive which is disposed on the element.

The effect of this is that particularly effective attachment of the adhesive to microstructures of the fibres can be achieved.

In one exemplary development the fibres are impregnated with an epoxy resin adhesive or a polyurethane adhesive and/or with a one-component adhesive or a two-component adhesive.

Details and advantages of the invention are described hereinafter with reference to working examples and to schematic drawings.

In the drawings:

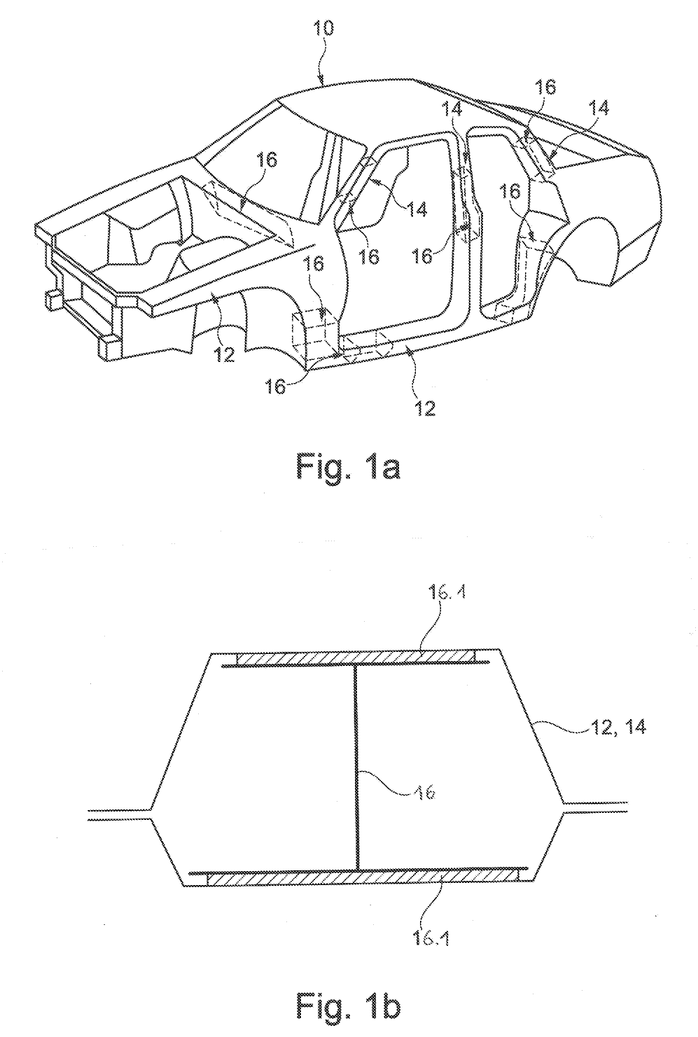

FIG. 1a shows a schematic representation of a vehicle body;

FIG. 1b shows a schematic representation of a reinforced cross section through a structural element; and

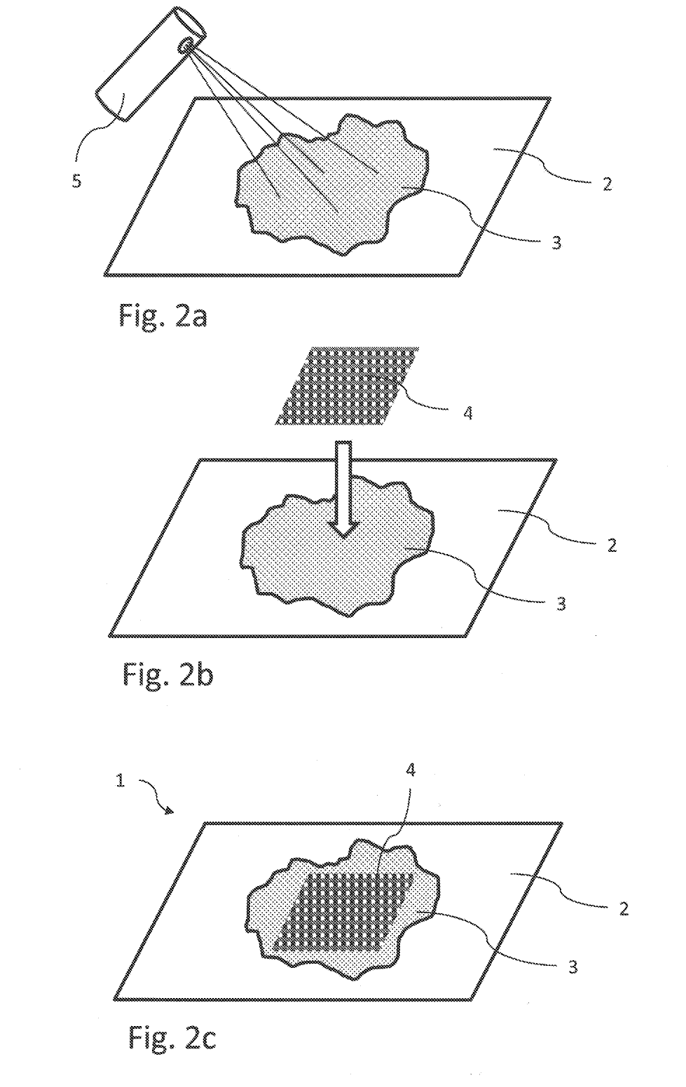

FIGS. 2a to 2c show a schematic representation of an exemplary method for reinforcing an element.

Represented schematically in FIG. 1a is the bodywork of a car. This bodywork 10 has various structures, including, in particular, pillars 14 and members or struts 12. Such structural elements 12, 14 with cavities are often reinforced with reinforcing elements 16.

Represented schematically in FIG. 1b is a cross section through a structural element 12, 14 having a cavity. In this case the structural element 12, 14 has an upper panel and a lower panel, which are assembled at joins and form a cavity between the joins. Disposed within this cavity is a reinforcing element 16, which is bonded with an adhesive 16.1 for bonding the reinforcing element 16 to the structural element 12, 14.

With the system proposed here of a reinforced element of a motor vehicle, and with the method proposed here for reinforcing an element of a motor vehicle, it is now possible to reinforce not only elements of the bodywork 10, such as panels, profiles or cast parts, for example, but also other elements, such as reinforcing elements 16, for example, which serve in turn to reinforce the bodywork 10.

With the system proposed here, for example, it is possible to carry out targeted reinforcement of the connection web of the reinforcing element 16.

Represented schematically in FIGS. 2a to 2c is an exemplary method for reinforcing an element of a motor vehicle.

In FIG. 2a, an applicator 5 disposes adhesive 3 on the element 2. In FIG. 2b, a sheetlike textile 4 is likewise disposed on the element 2. In FIG. 2c, the adhesive 3 is cured, so forming a system 1 of a reinforced element 2 of a motor vehicle, wherein the adhesive 3 is likewise a matrix resin for the fibres of the sheetlike textile 4 and bonds the sheetlike textile 4 to the element 2.

The method represented in FIGS. 2a to 2c for reinforcing an element 2 of a motor vehicle constitutes a working example in which the adhesive 3 and the sheetlike textile 4 are disposed separately onto the element 2 that is to be reinforced. In an alternative embodiment, not shown, the sheetlike textile and the adhesive are disposed jointly onto the element that is to be reinforced, by the impregnation, for example, of the sheetlike textile in the adhesive before being disposed on the element.

The method represented in FIGS. 2a to 2c for reinforcing an element 2 of a motor vehicle constitutes a working example in which the sheetlike textile 4 takes the form of a woven fabric. Alternatively to this it is also possible for other sheetlike textiles to be used, such as loop-drawn knits, nonwoven scrims, braided fabrics or loop-formed knits, for example.

The method represented in FIGS. 2a to 2c for reinforcing an element 2 of a motor vehicle constitutes a working example in which the adhesive 3 is sprayed by an applicator 5 onto the element 2. Alternatively to this, it is also possible to use other modes of disposing the adhesive, such as, for example, painting, brushing, extruding, pouring, or jointly contacting the adhesive with the sheetlike textile (for example, by impregnating the textile in adhesive before it is disposed on the element).

### LIST OF REFERENCE NUMERALS

1 system
2 element
3 adhesive
4 sheetlike textile
5 applicator
10 bodywork
12 structural element
14 structural element
16 reinforcing element
16.1 adhesive for bonding the reinforcing element to the structural element

1. A system of a reinforced element of a motor vehicle, the system comprising:
an element of a motor vehicle;
an adhesive, which is disposed on the element; and
a single sheetlike textile, which is disposed on the element;
where the one adhesive likewise forms a matrix resin for fibres of the sheetlike textile and bonds the sheetlike textile to the element.

2. The system according to claim 1, where the adhesive is a curable adhesive or a heat-curable adhesive which cures at a temperature of at least 120° C., and/or
where the adhesive is an epoxy resin adhesive or a polyurethane adhesive, and/or
where the adhesive is a one-component adhesive or a two-component adhesive.

3. The system according to claim 1, where the adhesive after curing has a modulus of elasticity of at least 100 MPa.

4. The system according to claim 1, where the adhesive is disposed as a film of adhesive on the element, and/or where the adhesive has an average thickness of 0.1 mm to 5 mm before full curing.

5. The system according to claim 1, where the sheetlike textile has a thickness of 0.5 mm to 1.5 mm, and/or where the sheetlike textile comprises glass fibres or carbon fibres.

6. The system according to claim 1, where the element is a section of the bodywork.

7. The system according to claim 1, where the sheetlike textile is a loop-drawn knit, a woven fabric, a nonwoven scrim, a braided fabric or a loop-formed knit.

8. A motor vehicle comprising a system according to claim 1.

9. A method for reinforcing an element of a motor vehicle, the method comprising the steps of:
disposing an adhesive on the element;
disposing a single sheetlike textile on the element; and
curing the adhesive;
where the adhesive likewise forms a matrix resin for fibres of the sheetlike textile and bonds the sheetlike textile to the element.

10. The method according to claim 9, where the adhesive and the sheetlike textile are disposed on the element in one step.

11. The method according to claim 10, where the method comprises the further step of:
impregnating the sheetlike textile in the adhesive before disposing the sheetlike textile and the adhesive on the element.

12. The method according to claim 9, where the sheetlike textile is a loop-drawn knit, a woven fabric, a nonwoven scrim, a braided fabric or a loop-formed knit.

13. The method according to claim 9, where the adhesive is disposed on the element before the sheetlike textile is disposed on the element.

14. The method according to claim 13, where the adhesive, on being disposed on the element is sprayed, scattered, painted, brushed, extruded or poured onto the element.

15. The method according to claim 9, where the method is carried out with a system of a reinforced element of a motor vehicle, the system comprising:
an element of a motor vehicle;
an adhesive, which is disposed on the element; and
a single sheetlike textile, which is disposed on the element;
where the one adhesive likewise forms a matrix resin for fibres of the sheetlike textile and bonds the sheetlike textile to the element.
